(19) United States
(12) Patent Application Publication
(10) Pub. No.: US 2007/0047696 A1
(43) Pub. Date: Mar. 1, 2007

(54) System for secret conversation and record

(76) Inventor: Zhongwen Chen, Dong Guang City (CN)

Correspondence Address: GLOBAL IP SERVICES, 2462 ROCK ST., APT. 6, MOUNTAIN VIEW, CA, 94043, US

(21) Appl. No.: 11/215,596

(22) Filed: Aug. 30, 2005

(51) Int. Cl. H04M 1/64

(52) U.S. Cl. 379/85

(57) ABSTRACT

A system for secret conversation and record of the present invention comprises a call-sending apparatus which has a function of sending and receiving calls; a call-receiving apparatus which has a function of sending and receiving calls and communicating with the call-sending apparatus; a record apparatus which can be outside connected to or inside set in the call-sending apparatus or the call-receiving apparatus to record and copy images or sounds wherefrom secretly; and a sound-controlled system which is connected with the call-sending apparatus or the call-receiving apparatus to monitor them when there is no person.

### FIELD OF INVENTION

This invention relates to communication transmission systems, more particularly to a system for secret conversation and record.

### BACKGROUND OF INVENTION

Conventional record system for wired telephone is mainly clear reminding record system, which record the conversation under the awareness of call sender. When the call gets through and no one answer, the inset recorder is switched on to get into record system automatically under the voice prompt from telephone answering device, so as to record sound contents of the opposite conversation part in the recorder for call receiver's check.

Systems for secret record in prior arts are mostly portable record pens, mini recorders or mobile phones; these record systems can work long-term and secretly record under unawareness of the opposite part. But on occasions of record prohibition, the record equipment is so easy to be detected by metal detector.

To settle the foregoing problems, it is desired to provide a system for secret conversation and record to receive, answer and record calls immediately and secretly.

### SUMMARY OF INVENTION

To overcome the drawbacks of the prior art, a main object of the present invention is to provide a system for secret conversation and record to provide a real time secret call-receiving and image and sound recording.

To achieve the above object, a system for secret conversation and record of the present invention comprises a call-sending apparatus, which has functions of sending and receiving calls; a call-receiving apparatus, which has functions of sending and receiving calls and communicating with call-sending apparatus; a record apparatus, which is outside connected to or inside set in the call-sending apparatus or call-receiving apparatus to record images or sounds wherefrom secretly; and a sound-controlled system, which is connected with the call-sending apparatus or call-receiving apparatus to monitor them when there is no people.

The call-sending apparatus comprises a radio system and a video system; and the call-receiving apparatus comprises a radio-receiving system and a video-receiving system. Both the call-sending apparatus and call-receiving apparatus comprise an intensified sound-centralization device, inside set or outside connected, to magnify radio signals intensively; and a cryptic receiving circuit arranged in the call-sending apparatus or call-receiving apparatus to control concealment or cut off incoming call promptly. The call-sending apparatus, call-receiving apparatus and record apparatus form a secret conversation and record system. The call-sending apparatus or call-receiving apparatus can be a telephone system or a computer communication system. The record apparatus can be a portable record equipment or computer.

As an embodiment, the call-sending apparatus or call-receiving apparatus further comprises a sound-dialing circuit to manipulate dialing by sound order; a fast dialing circuit to manipulate dialing by a single key or simple keys combination; and a remote control receiving/auto receiving or cutoff circuit to remote control the receival or cutoff of incoming calls.

As an embodiment, the call-sending apparatus or call-receiving apparatus further comprises a cryptic earphone or wireless cryptic ear microphone.

As an embodiment, the call-sending apparatus or call-receiving apparatus further comprises a dialing-and-receiving call filtration circuit to set the phone number or identity to be stopped to dial or receive.

As an embodiment, the call-sending apparatus or call-receiving apparatus further comprises a sound output control switch to make sending call and receiving call separated, so as to avoid transmission of radio signals from the call-receiving part to call-sending part.

Compared to prior art, the call-sending apparatus or call-receiving apparatus of the system for secret conversation and record of the present invention is equipped with a cryptic receiving circuit, radio signals can get received and answered secretly by using a cryptic earphone or wireless cryptic ear microphone; a Intensified sound-centralization device in the call-sending apparatus or call-receiving apparatus can intensify and magnify radio signals to improve the capability of gathering radio signals and conversation effect. Furthermore, the record apparatus is set in or connected outside to call-sending apparatus or call-receiving apparatus, which records contents of conversation directly and immediately for future check.

To make the invention easier to understand, thereafter follows an illustration of a system for secret conversation and record of the invention with reference to the drawings.

### BRIEF DESCRIPTION OF DRAWINGS

FIG. 1 is a flowchart showing the first embodiment of the system for secret conversation and record of the invention.

FIG. 2 is a flowchart showing the second embodiment of the system for secret conversation and record of the invention.

FIG. 3 is a flowchart showing the third embodiment of the system for secret conversation and record of the invention.

FIG. 4 is a flowchart showing the forth embodiment of one system for secret conversation and record of the invention.

FIG. 5 is a flowchart showing the fifth embodiment of the system for secret conversation and record of the invention.

FIG. 6 is a flowchart showing the sixth embodiment of the system for secret conversation and record of the invention.

FIG. 7 is a flowchart showing the seventh embodiment of the system for secret conversation and record of the invention.

FIG. 8 is a flowchart showing the eighth embodiment of the system for secret conversation and record of the invention.

### DESCRIPTION OF PREFERRED EMBODIMENTS

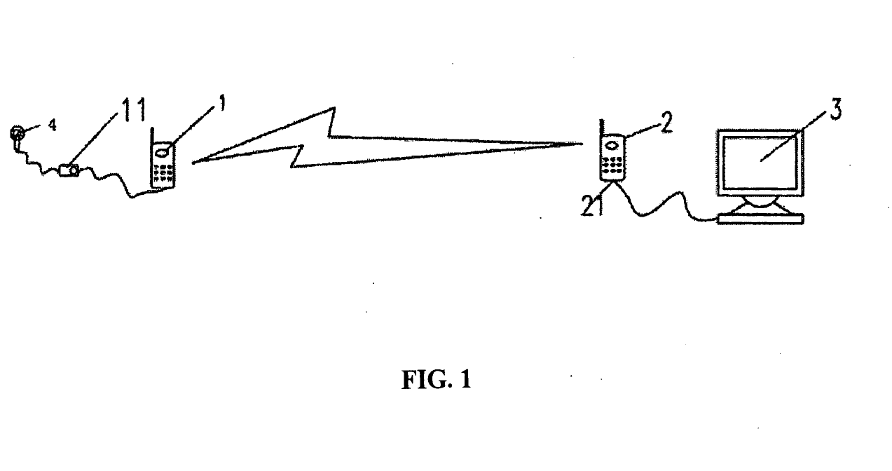

As shown in FIG. 1, a system for secret conversation and record mainly comprises a call-sending apparatus 1, a call-receiving apparatus 2 and a record apparatus 3. In an embodiment, taking mobile phone for example, the call-sending apparatus 1 and the call-receiving apparatus 2 have conversational functions of common mobile phones. The record apparatus 3 can be set in the call-sending apparatus 1, the call-receiving apparatus 2 or connected directly to the call-sending apparatus 1, the call-receiving apparatus 2, therefore it can make real time recording by entering it into record system automatically after starting conversation. Furthermore, an intensified sound-centralization device is outside-linked to call-sending apparatus 1 or call-receiving apparatus 2 to make radio signals intensive, so as to improve capability of gathering sounds from around circumstance, to avoid missing important information and to improve conversation quality. The call-receiving apparatus 2 is equipped with a sound output port to put vocal signals out.

### The First Embodiment

As shown in FIG. 1, when an user dials a number of the call-receiving apparatus 2 from the call-sending apparatus 1 and after connection with the call-receiving apparatus 2, the output radio signals from the call-sending part are transmitted to the call-receiving part for answer, the output radio signals sent to call-receiving apparatus 2 get intensified and magnified by an intensified sound-centralization device 11 of the call-sending apparatus 1, then they are transmitted to the call-sending apparatus for answer later. Meanwhile, the call-receiving apparatus 2 makes real time recording by the connected or inset record apparatus at the connection to the call-sending apparatus 1.

### The Second Embodiment

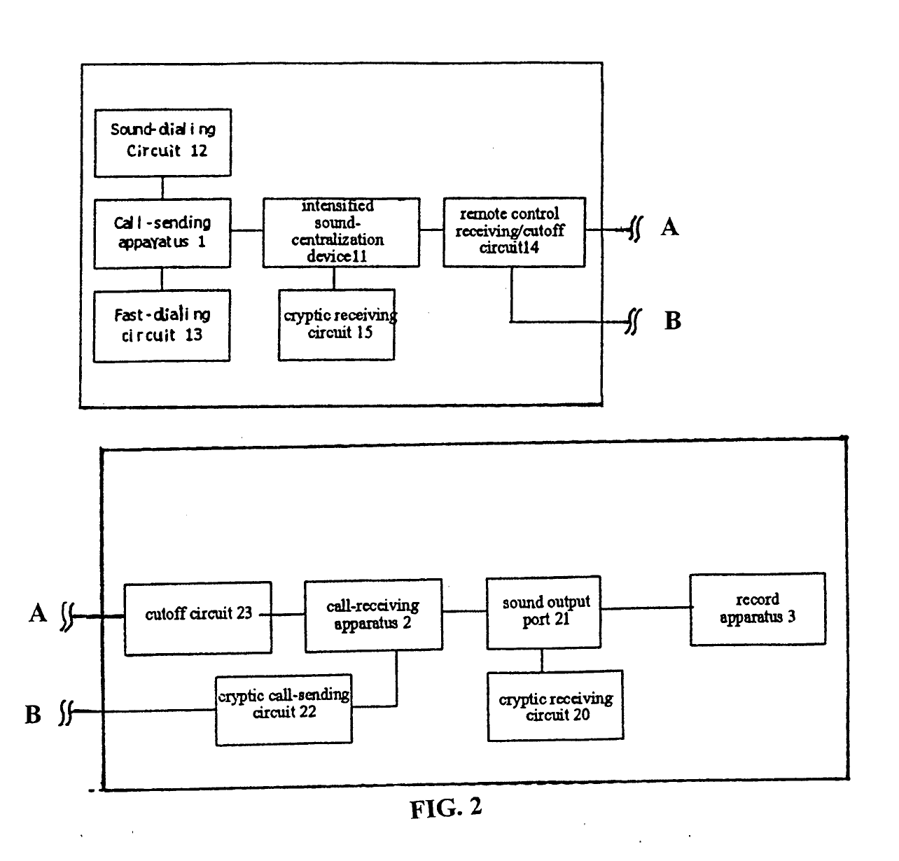

As shown in FIG. 2, to ensure the privacy of received call, a suitable modification can be made, such as the call-sending apparatus 1 and the call-receiving apparatus 2 are set as one-direction communication, which stops radio signals transmission from the call-receiving part to the call-sending part, so as to ensure the privacy of received call. A sound-dialing circuit 12 and fast-dialing circuit 13 are provided in the call-sending apparatus 1, an identical sound order activation is set in the sound-dialing circuit for user's cryptic operation at the end of call-sending apparatus 1 without manual operation. While single key or simple keys combination is set in the fast-dialing circuit 13 for connecting with the call-receiving apparatus 2, so as keeping secret from others' awareness.

Furthermore, a remote control receiving or cutoff circuit 14 is installed in the call-sending apparatus for connecting or cutting off conversation with the call-receiving apparatus 2. An automatic receiving or cutoff circuit 23 is installed in the call-receiving apparatus, which makes it optional to connect or cut off incoming calls from call-sending apparatus automatically without manual control by the user at the end of the call-receiving apparatus 2. Therefore, user can put the call-receiving apparatus 2 and record apparatus 2 in a sheltered place to avoid disturbance. The functions of automatic or remote control operation improve the condition of secret record. A cryptic receiving circuit is further provided in the call-sending apparatus to conceal or cut-off noise of the call-sending apparatus or massage of screen light.

When user of call-sending part chooses a sound-dialing circuit 12 or fast-dialing circuit 13 to connect with the call-receiving part, on one hand, user of the call-receiving part listens, secretly answers and asks through a sound output port 21, on other hand, he can make record by connecting or insetting record apparatus. User of the call-sending part can control the secret status of conversation by the cryptic receiving circuit to ensure the privacy thereof. During the process of conversation, call-sending part can choose automatic answer or cutoff the conversation with call-receiving part by insetting a remote control receiving or cutoff circuit 14. In the same way, call-receiving part can also choose automatic answer or cutoff the conversation with call-sending part by inset automatic receiving or cutoff circuit 23, this makes it convenient for both call-sending part and call-receiving part to secretly operate and control the status of conversation.

### The Third Embodiment

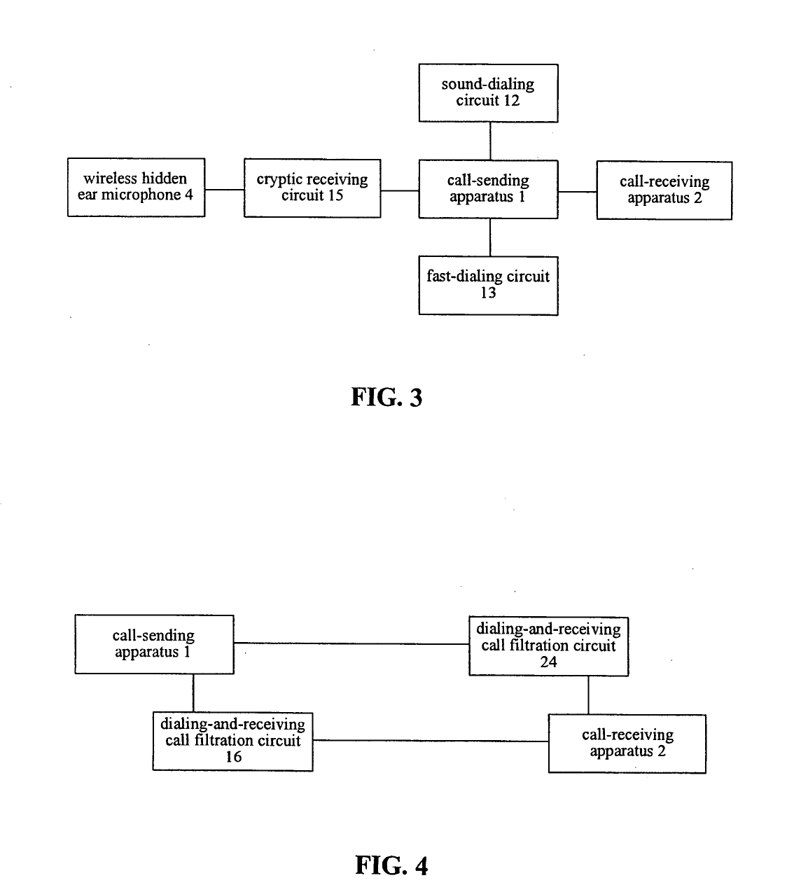

With reference to FIG. 3, a cryptic earphone or wireless hidden ear microphone 4 is further added to the call-sending apparatus 1. By the cryptic receiving circuit 15, the secret status of conversation can be controlled; by cryptic earphone or wireless hidden ear microphone 4, massage transmitted from call-receiving apparatus 2 can be received; sound-dialing circuit 12 or fast-dialing circuit 13 can be chosen to dial for call-receiving apparatus 2 to ensure the privacy of call-sending.

After the user of call-sending apparatus 1 chooses a sound-dialing circuit 12 or fast-dialing circuit 13 to connect with the call-receiving apparatus 2, the secret status of conversation is controlled and the prompt massage as noise of call-sending apparatus or screen light is alterable to hide or cut off by a cryptic receiving circuit 15. At this time, massages transmitted by call-receiving apparatus 2, which get answer from the cryptic earphone or wireless hidden ear microphone in order to achieve the effect of secret receival.

### The Forth Embodiment

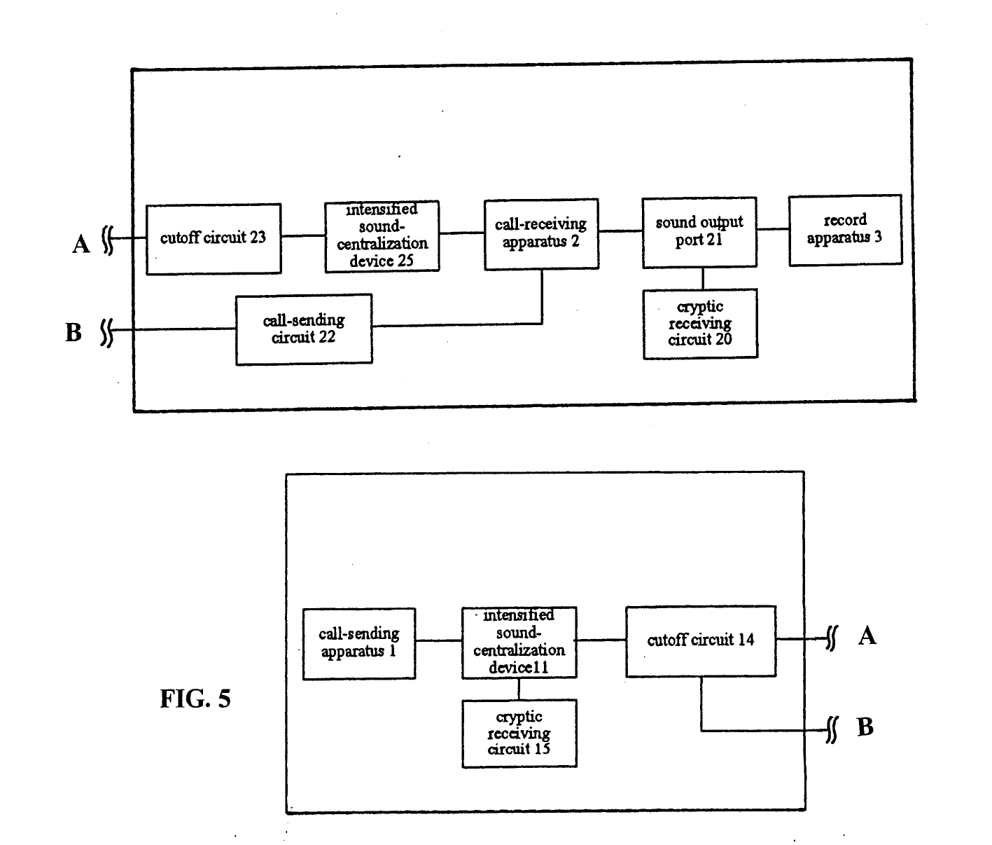

With reference to FIG. 4, to avoid other's dialing to the call-sending apparatus 1 or the call-receiving apparatus 2 at important moments, which will result interruption of receiving work and losing of important information, a dialing-and-receiving call filtration circuit 16, 24 are further provided in the call-sending apparatus or call-receiving apparatus. Conversation object can be set on the dialing-and-receiving call filtration circuit 16, 24, which thereby can check up the identity of dialing person initiatively to decide whether it should be connected or not when receiving others' signals. Thus, only mutual dialing between the required call-sending apparatus 1 and call-receiving apparatus 2 is set on essential occasion to ensure success ongoing of receiving work. Dialing ways are not restricted in the dialing-and-receiving call filtration circuit 16, 24 only, for example, password can be applied, the dialer must put in passwords first of all, of course other effective ways can also be applied.

### The Fifth Embodiment

With reference to FIG. 5, after the connection of call-sending apparatus 1 and call-receiving apparatus, radio signals of the call-receiving part are put out through the sound output port 21 of call-receiving apparatus 2 under magnification by the intensified sound-centralization device 25, then the user at the call-receiving receives and answers the massage from call-sending apparatus 1 by the cryptic earphone or wireless hidden ear microphone 4. In the meantime, radio signals exported from the sound output port 21 can be received and record down by the record apparatus 3 such as record equipment, computer and so on.

On one hand, the call-sending part answers radio signals transmitted from the call-receiving part after magnification by intensified sound-centralization device to ensure the clearance of conversation; on other hand, the call-sending part can transmit radio signals to the call-receiving part secretly by the cryptic call-sending circuit 22 to ensure the privacy of conversation. Meantime, the call-sending apparatus 1 can choose automatic answer or cutoff of incoming call through the remote control receiving or cutoff circuit 14; in the same way, the call-receiving part can choose automatic answer or cutoff of incoming call through the automatic receiving or cutoff circuit 23 to improve the secrecy of receival and answer.

In application of the present embodiment of the system for secret conversation and record, the call-sending part can be taken with oneself by the supervisee while the call-receiving part can be taken with oneself by the supervisor, when the supervisee is in danger or inconvenience waiting for the help from the supervisor, he can dial call-receiving apparatus 2 of supervisor and massage from the supervisee collected by intensified sound-centralization device 25 transfers to call-receiving apparatus 2 thereupon, by which valid information is given and accurate salvation is offered timely. Likewise; supervisor can find and know track of the supervisee. The supervisor can dial the call-sending apparatus 1 of the supervisee through the call-receiving apparatus 2 at the side of call-receiving part, then the massage that the supervisee received the supervisor's call is fed back to the supervisor by the intensified sound-centralization device 25, so as to interact with each other to fulfill the function of supervision.

### The Sixth Embodiment

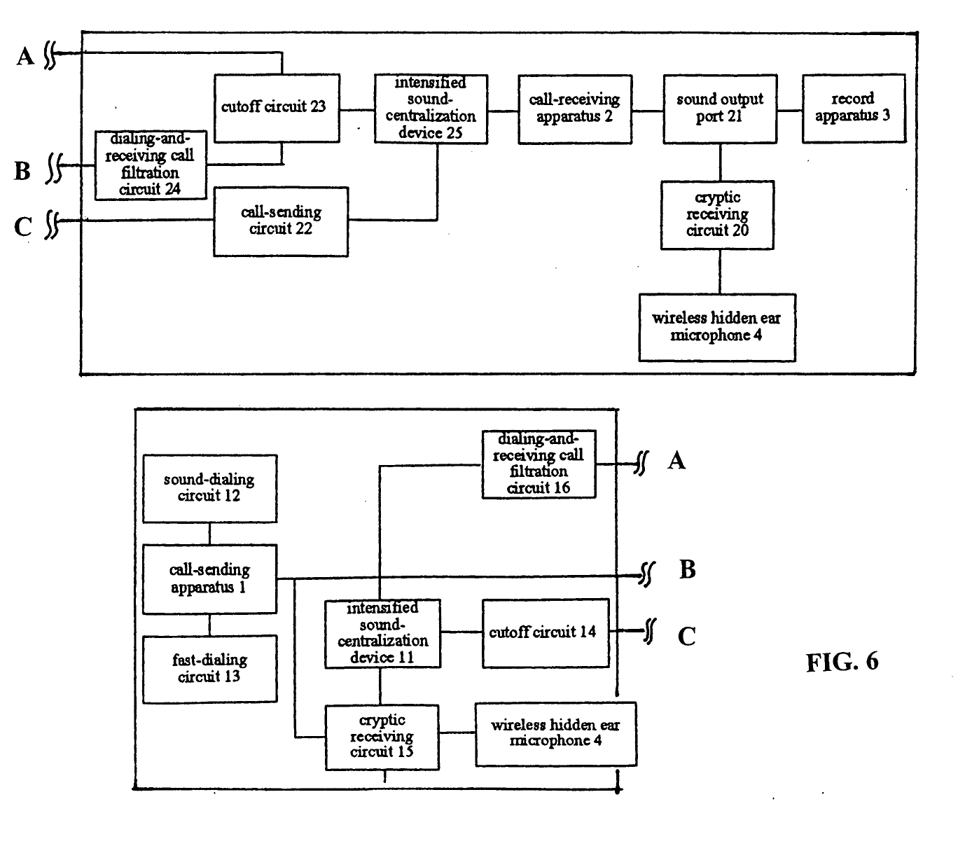

With reference to FIG. 6, when the call-sending apparatus 1 chooses a sound-dialing circuit 12 or fast-dialing circuit 13 to connect with the call-receiving apparatus 2, at the side of the call-receiving, radio signals sent from call-sending apparatus 1 can be filtered by the dialing-and-receiving call filtration circuit 24. If the call number should be stopped, the incoming call will be cut off by the automatic receiving or cutoff circuit 23, if the call number is permitted, the function of automatic answer will be activated and radio signals under magnification of the intensified sound-centralization device 25 is further transmitted to the call-receiving apparatus 2 and record apparatus 3, then putting out from sound output port 21 to make a secret record or an answer by the cryptic earphone or wireless cryptic ear microphone 4 provided by the cryptic receiving circuit 20. Meantime, the call-receiving apparatus 2 can send call to the call-sending apparatus 1 though the call-sending circuit 22 (secret), at the side of call sending, the transmission way of radio signals is the same as that of the call-receiving side to fulfill function of secret conversation and immediate record.

### The Seventh Embodiment

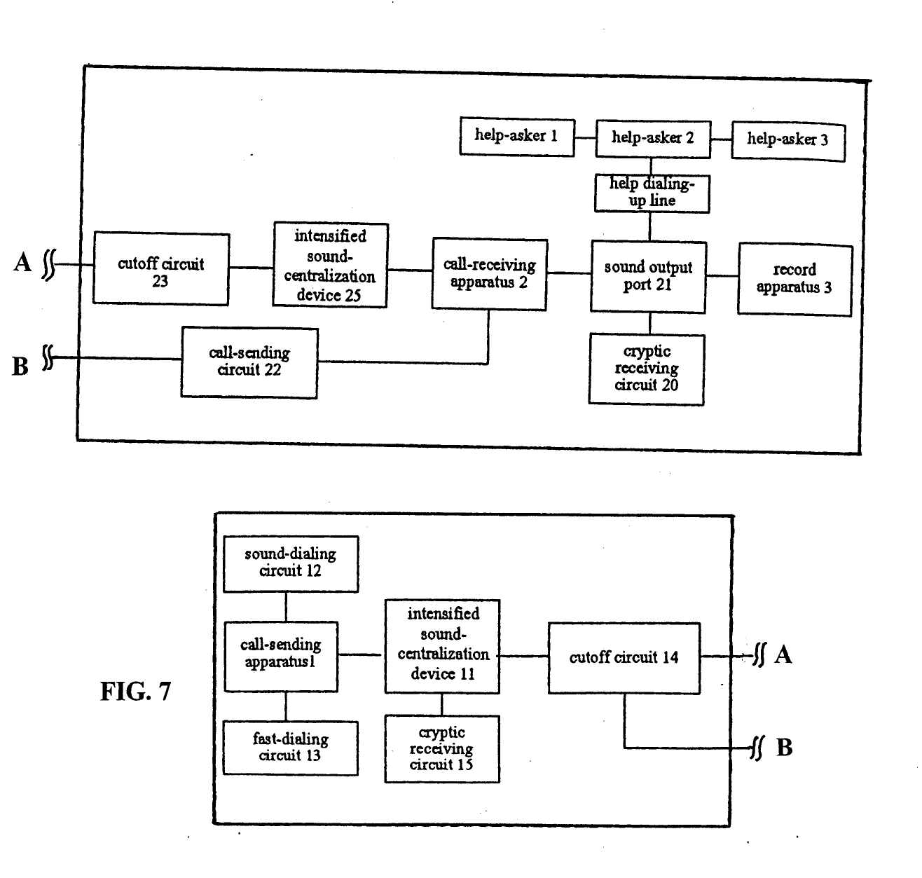

With reference to FIG. 7, when the user comes across a mishap, he can ask for help by call-sending apparatus 1. The help-asker under an accident dials the call-receiving apparatus 2 by operating dialing circuit 12 or fast-dialing circuit 13 for asking help, and the vocal help massage issued is transmitted to the call-receiving apparatus 2 after collections by the intensified sound-centralization device. Thus, help massage sent to rescuers will be gotten by help-askers since the call-receiving apparatus 2 choose automatic receiving or cutoff circuit 23 to control output-and-input of radio signals and the sound is output to help dialing-up line. By transmitting massages to the remote control receiving or cutoff circuit 14 on the side of call receiving, through the call-sending circuit 22 (secret) and then to help-askers by the call-receiving apparatus 1, the rescuer can tell help-asker the required measurements to carry out effective salvation.

### The Eighth Embodiment

Based on the sixth embodiment as shown in FIG. 6, the call sending and receiving system can be separated by arranging a control switch of sound output (not shown in drawings) at the call-sending side of the call-receiving apparatus 2. Two-lateral and independent call sending will be achieved separately with turn-on of the control switch of sound output, and sounds of the side of call-receiving apparatus 2 will surely not pass to the call-sending apparatus 1 with turn-off thereof on the counterpart, to reduce the disturbance and distraction of the meeting content.

In the present invention, both the call-sending apparatus 1 and call-receiving apparatus 2 can send and receive call independently and the cryptic receiving circuit 15 arranged inside call-sending apparatus 1 makes incoming calls prompt secret without discovering by others; While the user of call-sending apparatus 1 can receive and answer by cryptic earphone 4, so the operation is also quite secret. When the user uses call-sending apparatus 1 to dial the number of call-receiving apparatus 2 by the way of sound-dialing and fast dialing, the call-receiving apparatus 2 will choose connection to incoming call through automatic receiving or cutoff circuit 23 to receive radio signals from call-sending side, and to send the conversation of both parties to the record apparatus 3 in connection with the call-sending apparatus 1 or the call-receiving apparatus 2.

The intensified sound-centralization device 25 can be arranged inside or connected outside to the call-sending apparatus 1 and call-receiving apparatus 2 to magnify radio signals and intensify the function of receiving sounds, ensuring the clearance of conversation.

The record apparatus 3 can be arranged inside or connected outside to the call-sending apparatus 1 and call-receiving apparatus 2 for two parties making secret record while sending and receiving call to get a copy of content of conversation. Among them, the outer-linked record apparatus 3 can be a portable record equipment or computer.

### The Ninth Embodiment

The call-sending apparatus 1 of the system for secret conversation and record of the invention is equipped with a sound-controlled system, a radio system and a video system. The call-receiving apparatus 2 is equipped with a radio-receiving system and video-receiving system; meantime, video record apparatus is also arranged except radio record apparatus therein. For example, call-sending apparatus 1 is positioned in A place while the call-receiving apparatus 2 is positioned in B place.

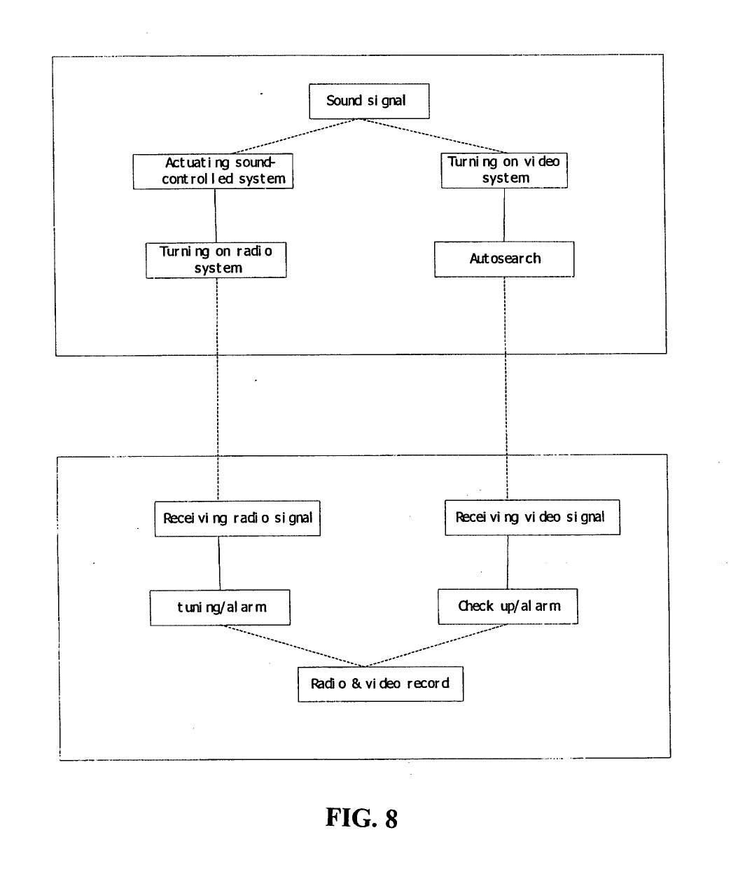

With reference to FIG. 8, when there is no people's abnormal sound sent from A place, the system will automatically actuate sound-controlled system of call-sending apparatus 1 and turn on video system in A place, then radio system will get switched on subsequently and the actuated video system begins to auto-search and transmits the gotten data to receiving system of the call-receiving apparatus 2 in B place. At the same time, radio-receiving system and video-receiving system of the call-receiving apparatus 2 in B place take the radio and video signals sent from call-sending apparatus 1 to tune, send an alarm or check up separately. Meantime, it can make immediate record what happened in A place as proof of future.

The above embodiment can be applied in such as the wired communication, wireless communication and network communication system and so on, of course, the embodiment is not limited to applications in long-distance supervision, alarm, guard against theft, and also can be used in fireproofing field.

It is understood that the invention may be embodied in other forms without departing from the spirit thereof. Thus, the present examples and embodiments are to be considered in all respects as illustrative and not restrictive, and the invention is not to be limited to the details given herein.

What is claimed is:

1. A system for secret conversation and record, which comprising:
a call-sending apparatus which has functions of sending and receiving calls;
a call-receiving apparatus which has functions of sending and receiving calls and communicating with said call-sending apparatus;
a record apparatus which is outside connected to or inside set in said call-sending apparatus or said call-receiving apparatus to record and copy images or sounds wherefrom secretly; and
a sound-controlled system which is connected with said call-sending apparatus or said call-receiving apparatus to monitor them when there are no people.

2. The system for secret conversation and record according to claim 1, wherein said call-sending apparatus is equipped with a radio system and a video system, said call-receiving apparatus is equipped with a radio-receiving system and a video-receiving system.

3. The system for secret conversation and record according to claim 1, wherein both said call-sending apparatus and said call-receiving apparatus comprise:
an intensified sound-centralization device, inside set or outside connected, to magnify radio signals intensively; and
a cryptic receiving circuit arranged in said call-sending apparatus or said call-receiving apparatus to control concealment or cutoff of incoming calls promptly, wherein said call-sending apparatus or said call-receiving apparatus get connected together with said record apparatus to form said secret conversation and record system.

4. The system for secret conversation and record according to claim 1, wherein said call-sending apparatus or said call-receiving apparatus further comprises a sound-dialing circuit to manipulate dialing by sound order, and a cryptic earphone or wireless cryptic ear microphone.

5. The system for secret conversation and record according to claim 1, wherein said call-sending apparatus or said call-receiving apparatus further comprises a fast dialing circuit to manipulate dialing by setting a single key or simple keys combination.

6. The system for secret conversation and record according to claim 5, wherein said call-sending apparatus or said call-receiving apparatus further comprises a dialing-and-receiving call filtration circuit to set the call number or identity to be stopped to dial or receive.

7. The system for secret conversation and record according to claim 6, wherein said call-sending apparatus or said call-receiving apparatus further comprises a remote control receiving or cutoff circuit to remote control receival or cutoff of incoming calls.

8. The system for secret conversation and record according to claim 6, wherein said call-sending apparatus or said call-receiving apparatus further comprises a auto receiving or cutoff circuit to auto-control receival or cutoff of incoming calls.

9. The system for secret conversation and record according to claim 6, wherein said call-sending apparatus or said call-receiving apparatus further comprises a sound output control switch to separate sending call and receiving call so as to avoid transmission of radio signals from said call-receiving part to said call-sending part.

10. The system for secret conversation and record according to claim 9, wherein said call-sending apparatus or said call-receiving apparatus is a telephone system or a computer communication system, and said record apparatus is a portable record equipment or computer.
